(19) United States
(12) Patent Application Publication
(10) Pub. No.: US 2008/0274401 A1
(43) Pub. Date: Nov. 6, 2008

(54) Oxygen gas sensor

(75) Inventors: Stephen H. Broy, Riverside, CA (US); Zhenhe Sun, Diamond Bar, CA (US)

Correspondence Address: K&L GATES LLP, 535 SMITHFIELD STREET, PITTSBURGH, PA, 15222, US

(73) Assignee: Teledyne Technologies Incorporated

(21) Appl. No.: 11/800,178

(22) Filed: May 4, 2007

(51) Int. Cl. G01N 27/26; H01M 2/00

(52) U.S. Cl. 429/163; 204/412

(57) ABSTRACT

A gas sensor includes an electrochemical cell. The electrochemical cell includes a body defining a cavity to contain a predetermined volume of electrolyte solution. The plurality of electrodes is disposed within the cavity and comprises an electrically conductive material that is substantially free of hazardous material. An energy module is coupled to the plurality of electrodes. The energy module provides a bias voltage suitable to reduce gas diffused in the electrolyte solution. An electrical interface is coupled to the energy module. The electrical interface has an electrical and mechanical form-factor to enable the gas sensor to replace a lead-based anode galvanic oxygen gas sensor as a drop-in replacement.

### BACKGROUND

Gas monitors and analyzers are employed to monitor and analyze concentrations of a gas in a specific atmosphere. The gas monitors employ a gas sensor that is designed to detect the presence of a particular gas. The gas sensor produces an electrical signal that is proportional to the concentration of the gas to be detected. The electrical signal is provided to a processing module in the gas monitor/analyzer where the electrical signal from the sensor may be amplified, converted to a digital signal suitable to display the gas presence/concentration, and compared to alarm set points to trigger an alarm.

Examples of gas monitors/analyzers include oxygen monitor/analyzer that provide fast and accurate oxygen monitoring and incorporate audio/visual alarm capability. Such instruments may be designed to monitor up to 100% oxygen concentration in medical gas mixtures. For example, oxygen analyzers can continuously measure, verify and display oxygen concentrations in gas mixtures used in medical applications such as anesthesia and respiratory therapy for adult, pediatric, and neonatal populations. An oxygen monitor/analyzer typically includes a galvanic oxygen sensor. The oxygen sensor is made up of a sensing cathode and a lead anode immersed in a caustic electrolyte solution and packaged in a small plastic container. Oxygen gas enters the sensor through a gas permeable membrane and is electrochemically reduced at cathode. In the meantime, lead anode is electrochemically oxidized, an electrical current is generated as an output signal that may be coupled the electronic processing module of the monitor/analyzer.

FIG. 1 shows a conventional lead-based anode galvanic oxygen sensor 100, for example, a Teledyne Analytical Instruments model R17MED galvanic oxygen sensor available from Teledyne Electronic Technologies, City of Industry, Calif. The gas sensor 100 includes an electrochemical cell 145 comprising a cathode 142 and an lead-based anode 144 sealed in a cell body 146 filled with a suitable volume of electrolyte solution 148. Oxygen is received at a first end 162 of the gas sensor 100 through a first opening 166 and diffuses into the interior of the cell body 146 through a gas permeable sensing membrane 149. A flexible expansion membrane 150 at a second end 164 of the gas sensor 100 is provided over a second opening 168 and permits the expansion or contraction of the electrolyte solution 148 volume. The sensing membrane 149 may be sealed in place by press fitting, and the expansion membrane 150 may be sealed in place by heat sealing. Oxygen gas is reduced at the cathode 142 and causes current to flow from the cathode 142 to the anode 144 through an externally connected sensing circuit via a circuit board 152. The cell body 146 and the circuit board 152 of the gas sensor 100 are contained in a housing 154 that may be connected to one of various types of process equipment and/or analyzers using a variety of attachment means well known to those of ordinary skill in the art. The cathode 142 and the anode 144 are coupled to the circuit board 152 and the external sensing circuit via respective first and second electrically conductive elements 156, 158. The circuit board 152 is coupled to external devices via an interface 159. As illustrated in FIG. 1, the interface comprises first and second connectors 160A and 160B, which are coupled to the respective first and second conductive elements 156, 158. Electrical connection between the sensing circuit 152 and the cathode 142 may be made by attaching the first conductive element 156 to the cathode 142. The first conductive element 156 may be a small diameter (typically≈0.01 inch) wire of silver, gold, platinum, nickel, copper, and stainless steel and can be welded to the cathode 142. Electrical connection between the sensing circuit board 152 and the anode 144 may be made by attaching the second conductive element 158 to the anode 144 in the same manner as cathode 142. In one example, the second conductive element 158 may be attached to the anode 144 by compressing (sintering) lead pellets around a small coil of nickel wire in an attempt to maximize the contact surface area between the wire and the lead particles. A cable (not shown) is received at the second 164 to electrically plug into the two terminal interface 159 comprising connectors 160A, B.

The cell body 146 of the lead-based galvanic gas sensor 100 may be formed of a machined plastic body. The cathode 142 may be manufactured from perforated sheet metal such as, for example, brass and plated with an appropriate noble metal such as, for example, rhodium, gold, or silver. The anode 144 is formed of compressed lead pellets. The electrolyte solution 148 may be potassium hydroxide. A gaseous stream enters the cell body 146 at the first end 162 and diffuses through the sensing membrane 149 positioned at an inlet and is transported through the electrolyte solution 148 to the cathode 142. The oxygen is reduced to form hydroxyl ions at the cathode 142. Simultaneously, anode material, such as lead, is oxidized at the anode 144.

Thus, the following set of electrochemical reactions occur at the cathode 142 and the lead anode 144:

Cathode: O₂+2H₂O+4e⁻→4OH⁻

Anode: 2Pb→2Pb²⁺+4e⁻

Then, the reaction inside the cell is: 2Pb+2H₂O+O₂→2Pb²⁺+4OH⁻→2Pb(OH)₂→2PbO+2H₂O

Thus, the overall reaction is: 2Pb+O₂→2PbO

Lead oxide will eventually deposit on the lead anode 144 as the electrolyte solution 148 becomes saturated with lead ions. When the cathode 142 and the anode 144 are electrically connected externally via circuit board 152, a current flow through the gas sensor 100. The current is proportional to the rate of oxygen concentration and converted to voltage, which can be measured by an electronic device.

There has been an increasing demand on manufactures of gas sensors to eliminate the use of lead in their products. It is anticipated that the use of lead in gas sensors will eventually be prohibit worldwide. European regulations, for example, are forcing manufacturers to eliminate the use of lead in their products for environmental reasons to comply with the Restriction of Hazardous Substance Directive (RoHS) 2002/95/EC adopted in February 2003 by the European Union. The RoHS directive restricts the use of six hazardous materials, which included lead in the manufacture of various types of electronic and electrical equipment. It is closely linked with the Waste Electrical and Electronic Equipment Directive (WEEE) 2002/96/EC which sets collection, recycling and recovery targets for electrical goods and is part of a legislative initiative to solve the problem of huge amounts of toxic e-waste.

Thus, there is a need for a lead-free oxygen gas sensor. In addition, there is a need for a lead-free oxygen sensor having a form factor suitable to replace existing lead based oxygen sensors.

### SUMMARY

One embodiment includes a lead-free oxygen sensor that can replace the conventional lead-based oxygen sensor. In one embodiment, an oxygen gas sensor comprises a body defining a cavity to contain a predetermined volume of electrolyte solution. A plurality of electrodes is disposed within the cavity. The plurality of electrodes comprises an electrically conductive material that is substantially free of hazardous material. An energy module is coupled to the plurality of electrodes. The energy module is to provide a bias voltage suitable to reduce oxygen diffused in the electrolyte solution. An electrical interface is coupled to the energy module. The electrical interface has an electrical and mechanical form-factor to enable the gas sensor to replace a lead-based anode galvanic oxygen sensor as a drop-in replacement.

### BRIEF DESCRIPTION OF THE DRAWINGS

FIG. 1 is a cross-sectional view of a conventional oxygen gas sensor.

FIG. 2 is a cross-sectional of one embodiment of a gas sensor.

FIG. 3 is a diagram of one embodiment of a system comprising the gas sensor illustrated in FIG. 2.

### DESCRIPTION

Various embodiments of a gas sensor are described and illustrated. In one embodiment, the gas sensor may be adapted for use as a sealed oxygen sensor. It will be understood, however, that the embodiments are not limited in this context and may be applied in any suitable gas sensing apparatus or system. Various embodiments of a gas instrument employing the gas sensor are described and illustrated. In one embodiment, the gas instrument may be a gas monitor/analyzer to measure, monitor, and analyze concentrations of oxygen employing a sealed oxygen sensor. It will be understood, however, that the embodiments are not limited in this context and may be applied in any suitable gas sensing apparatus or system. Although the embodiments may be implemented in multiple forms, for convenience and clarity, this detailed description and the accompanying drawings disclose only specific forms as examples. Those having ordinary skill in the relevant art will be able to adapt the embodiments to application in other forms not specifically presented herein based upon this description.

Also, for convenience and clarity, the embodiments of the gas sensor and any elements, components, or devices to which it may be attached may be described herein in a normal operating position, and terms such as upper, lower, front, back, horizontal, proximal, distal and may be used with reference to the normal operating position of the referenced elements, components, or devices. It will be understood, however, that embodiments of the gas sensor apparatus may be manufactured, stored, transported, used, and sold in orientations other than those described herein.

Other than in the examples herein, or unless otherwise expressly specified, all of the numerical ranges, amounts, values, and percentages, such as those for dimensions, and others, in the following portion of the specification and attached claims may be read as if prefaced by the word “about” even though the term “about” may not expressly appear with the value, amount, or range. Accordingly, unless indicated to the contrary, the numerical parameters set forth in the following specification and attached claims are approximations that may vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting are approximations, the numerical values set forth in the specific examples are reported as precisely as possible. Any numerical value, however, inherently contains error necessarily resulting from the standard deviation found in its underlying respective testing measurements. Furthermore, when numerical ranges are set forth herein, these ranges are inclusive of the recited range end points (i.e., end points may be used).

Each of the various embodiments of the gas sensor described herein comprises lead-free reference and counter electrodes immersed in an electrolytic solution. For example, the embodiments of the gas sensor described herein do not employ a lead counter electrode or anode or any other lead-based electrode element or component. A potentiostat circuit may be configured to supply energy to the gas sensor necessary to enable oxygen reduction to occur in the absence of lead-based electrodes. Electrical circuit elements may be configured to supply power to the potentiostat circuit and to provide an electrical signal with characteristics that are substantially similar to the output of a “lead-based anode” type gas sensor. Accordingly, embodiments of the gas sensor may be fabricated with a form factor suitable to replace existing lead-based galvanic gas sensors as a drop-in replacement. Presently, there are many instruments in the filed configured to operate with lead-based galvanic gas sensors. Thus, a substantially lead-free gas sensor with a drop-in replacement form factor may be employed to replace the lead-based anode galvanic type gas sensors in existing instruments. This may be desirable, for example, for environmental reasons to eliminate the use of hazardous materials in general or to comply with environmental standards or regulations with respect to the use and disposal of hazardous materials (e.g., lead). A substantially lead-free gas sensor with a drop-in replacement form factor provides a significant advantage in lieu of replacing the entire instrument or adapting the instrument to receive a new gas sensor with a different form factor.

Accordingly, in one embodiment, a gas sensor comprises an electrochemical cell. The electrochemical cell comprises a body defining a cavity to contain a predetermined volume of electrolyte solution. The plurality of electrodes is disposed within the cavity and comprises an electrically conductive material that is substantially free of hazardous material. In one embodiment, the plurality of electrodes is disposed within the cavity and is formed of an electrically conductive material that is substantially free of hazardous material. An energy module is coupled to the plurality of electrodes. The energy module provides a bias voltage suitable to reduce oxygen diffused into the electrolyte solution. An electrical interface is coupled to the energy module. The electrical interface has an electrical and mechanical form-factor to enable the gas sensor to replace a lead-based anode type galvanic gas sensor as a drop-in replacement.

In one embodiment, each of the plurality of electrodes comprises materials such as rhodium, gold, silver, or platinum. Each of the plurality of electrodes comprises or is formed of materials that are substantially lead-free.

In one embodiment, the plurality of electrodes comprise a first and a second electrode adapted to couple a bias voltage from the energy module. A third electrode is coupled to the energy module to collect a current proportional to the amount of oxygen reduced by the sensing electrode. The sensing current is coupled to a processing module via the electrical interface.

In one embodiment, the gas sensor comprises a lead-free battery coupled to the energy module.

In one embodiment, the first, second, and third electrodes of the electrochemical cell are coupled to respective first, second, and third electrically conductive members. The first, second, and third electrically conductive elements are formed of about a 0.01 inch diameter of gold, nickel, copper, stainless steel, or any other suitable wire that can be welded, soldered, brazed, or otherwise joined to other electrical conductor elements. The plurality of electrodes is adapted to couple to an electrical interface having an electrical and mechanical form-factor to enable the electrochemical cell to replace a lead-based anode type galvanic cell as a drop-in replacement.

In one embodiment, the electrolyte solution comprises a potassium hydroxide solution (KOH). For example, the electrolyte solution comprises a 5 to 30% KOH solution. For example, the electrolyte solution comprises a 10 to 20% KOH solution.

In one embodiment, a gas measurement instrument comprises a gas sensor as described above and a display to indicate the presence or concentration of the gas monitored by the gas sensor. The instrument may comprise an alarm module to compare the concentration of the monitored gas to a predetermined level and to trigger an alarm signal when the measured concentration of the monitored gas is at least at the predetermined level.

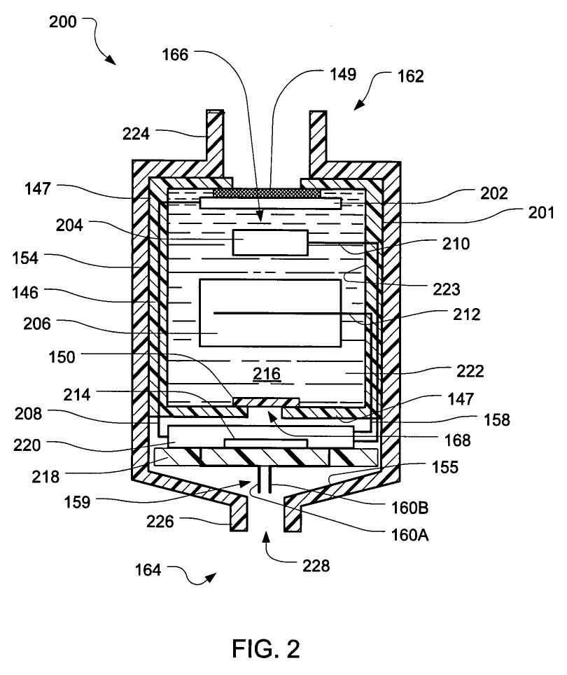

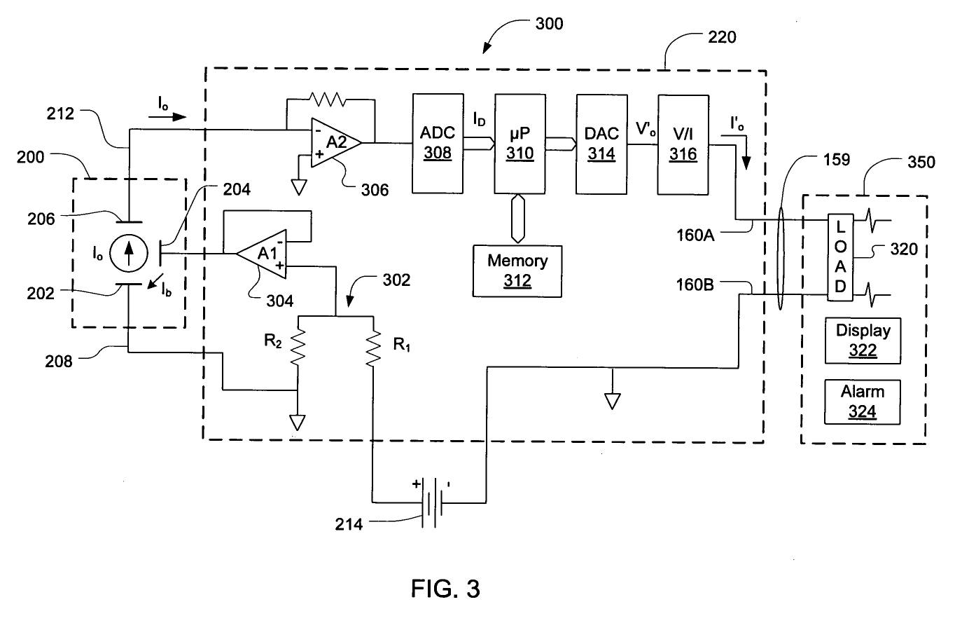

FIG. 2 is a cross-sectional view of one embodiment of a gas sensor 200. In the embodiment illustrated in FIG. 2, the gas sensor 200 comprises an electrochemical cell 201 and a circuit board 218 that comprising an energy module 220. The gas sensor 200 generates an electrical signal that is proportional to the concentration of oxygen to be detected. The electrochemical cell 201 is coupled to a processing module 350 (FIG. 3) via an interface 159. In the embodiment illustrated in FIG. 2, the electrochemical cell 201 comprises a sensing electrode 202 (e.g., working electrode), a reference electrode 204, and a counter electrode 206 sealed within a cell body 146 filled with a suitable volume of electrolyte solution 216. The electrochemical cell 201 interfaces with the circuit board 218 and the energy module 220 via three terminals. The three terminals are coupled to first, second, and third electrically conductive elements 208, 210, 212 each of which is coupled to the respective sensing electrode 202, reference electrode 204, and counter electrode 206.

Gas is received at a first end 162 of the gas sensor 200 via a first opening 166 extending through the electrochemical cell 201 and diffuses into the interior of the cell body 146 through a gas permeable sensing membrane 149. A flexible expansion membrane 150 is provided over a second opening 168 formed in the cell body 146 at a second end 164 of the electrochemical cell 201. The expansion membrane 150 permits the expansion or contraction of the volume of the electrolyte solution 216 contained in the cell body 146 of the electrochemical cell 201. The sensing membrane 149 may be sealed in place by press fitting. The expansion membrane 150 may be sealed in place by heat sealing. As previously discussed, the cell body 146 may be formed of a machined plastic body.

In the embodiment illustrated in FIG. 2, the housing 154 may be formed as open ended cylinder which comprises the cell body 146, the circuit board 218, and the energy module 220. A cavity 222 is defined by an internal wall 223 of the cell body 146. The cell body 146 and/or the housing 154 may be a single formed component or may be separately formed components that are secured together by any known method such as, for example, heat sealing, welding, or press fit. All components that form the cell body 146 and/or the housing 154 may be formed separately or as a single unit through processes such as, for example, pouring or injection molding. The cell body 146 and/or the housing 154 may be fabricated from, for example, any resilient, insulating material, which material includes thermoplastic material such as, for example, polyethylene. The cell body 146 and/or the housing 154 may be any shape, but, as incorporated into the gas sensor 200, is a cylindrical body with the internal and external walls being generally coaxial, as illustrated. The cell body 146 and/or the housing 154 may have any suitable dimensions, and as incorporated in the gas sensor 200 may have, for example, a longitudinal length of about 1.25 inches and a diameter of about 1.2 inches. Other housing dimensions will follow from the application for which the sensor is adapted. Therefore, the embodiments are not limited in this context.

The housing 154 includes a first end 162 defining a first opening 166 and a second end 164 defining a second opening 168. The first opening 166 receives an entering stream of gas to be sensed. The first opening 166 may be any size or shape suitable for receiving the gaseous stream. In the embodiment illustrated in FIG. 2 and as incorporated in the gas sensor 200, the first opening 166 is circular and has a diameter of about 0.9 inches. As illustrated, the first opening 166 may be located within a recessed portion of the first end 162 and may be centrally spaced relative to the external wall 147 of the cell body 146 and/or housing 154. The first end 162 of the housing 154 comprises a neck 224 portion adapted to fluidically couple the gas sensor 200 to an instrument. The second end 164 of the housing 154 comprises a neck 226 portion adapted to electrically couple the gas sensor 200 to the instrument. The instrument may comprise any suitable gas monitors/analyzers including, for example, oxygen monitor/analyzer instruments that provide fast and accurate oxygen monitoring and incorporate audio/visual alarm capability.

The second opening 168 in the cell body 146 may be positioned opposite the first opening 166 and may be defined by the external wall of the cell body 146. The second opening 168 may be any size or geometry suitable for receiving the expansion membrane 150. In the embodiment illustrated in FIG. 2, the second opening 168 is circular having a diameter of about 1.0 inches and is centrally positioned relative to the external wall of the cell body 146 and/or housing 154. The second opening 168 may be formed to accommodate the total thickness of the expansion membrane 150.

The internal wall 223 of the cell body 146 defines the cavity 222 that extends from the first opening 166 to the second opening 168 to provide fluid communication to the electrolyte solution 216 for the gases entering through the first opening 166. As adapted for use in the gas sensor 200, the internal wall 223 defining the cavity 222 may have a longitudinal length of about 0.93 inches. It will be understood that the cavity 222 may be formed as an annular chamber defined by the interior dimensions of the cell body 146. The cavity 222 may be formed of any suitable size and geometry suitable for containing an adequate amount of the electrolyte solution 216 sufficient for the effective measurement of the gaseous stream entering through the first opening 166.

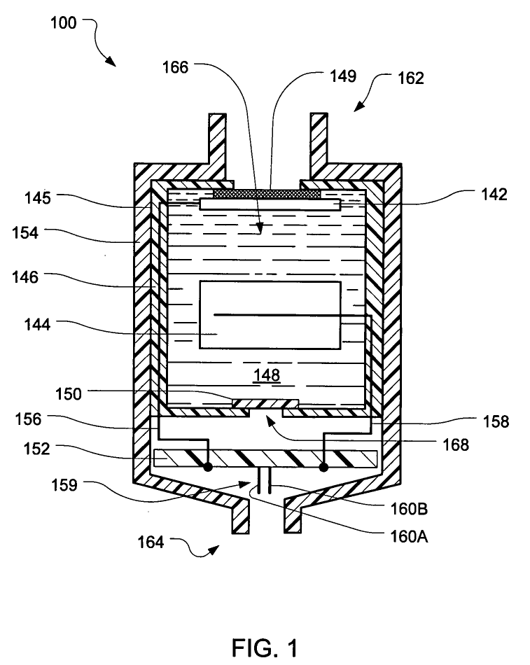

A third opening 228 is provided at the second end 164 of the gas sensor 200. The third opening 228 is defined by the interior wall 155 of the housing 154 and the exterior wall 147 of the cell body 146 at the second end 164. The third opening 228 is suitable to contain the circuit board 218 and the energy module 220. A cable (not shown) is received at the second end 162 through the third opening 228 to electrically couple the electrolytic cell 201 to the processing module 350 (FIG. 3) via an interface 159. The interface 159 is electrically and mechanically compatible in form factor with existing lead-based galvanic gas sensors to enable the gas sensor 200 to be used as a drop-in replacement for existing lead-based galvanic gas sensors. In the embodiment illustrated in FIG. 2, the interface 159 comprises a two terminal connection referred to herein as connectors 160A, B. For example, the connectors 160A, B may electrically couple the electrical signal generated by the gas sensor 200 to a gas analyzer. As previously discussed, the electrical signal of the gas sensor 200 is substantially similar to the electrical signal of the lead-based anode gas sensor 100 (FIG. 1). This allows the gas sensor 200 to be a used as a drop-in replacement for the lead-based anode gas sensor 100 (FIG. 1). In the embodiment illustrated in FIG. 2, the interface 159 is shown and described as a two terminal interface. In other embodiments, however, the interface 159 may comprise multiple terminals. Therefore, the embodiments are not limited in this context.

In various embodiments, the sensing electrode 202, the reference electrode 204, and the counter electrode 206 may be formed of any suitable electrically conductive material. For example, the sensing electrode 202 may be fabricated from solid or plated with rhodium, gold, silver, or platinum, or any suitable non-hazardous conductive material. In one embodiment the counter electrode 206 may comprise a suitable surface area that can evolution of oxygen. The reference electrode 204 and the counter electrode 206 may be formed of silver, platinum, gold, radium noble metals and their compounds. The sensing electrode 202, the reference electrode 204, and the counter electrode 206 are coupled to the circuit board 218 and the energy module 220 via respective first, second, and third electrically conductive elements 208, 210, 212. The first, second, and third electrically conductive elements 208, 210, 212 may be formed of a small diameter (typically≈0.01 inch) wire of silver, copper, nickel, platinum, gold, stainless steel and their alloys that can be welded, soldered, brazed, or otherwise joined to other electrical conductor elements. The circuit board 218 is coupled to external devices via connectors 160A and 160B via the third opening 228.

The sensing membrane 149 may be formed of any suitable material that has a low coefficient of friction and is non-reactive with reactive or corrosive chemicals. For example, the sensing membrane 149 may be formed of a synthetic fluoropolymer such as polytetrafluoroethylene (PTFE). PTFE is a well known under the trademark and DuPont brand name TEFLON®. The sensing membrane 149 may be heat-sealed over the sensing electrode 202.

In one embodiment, the electrolyte solution 216 may be comprise a substance containing free ions that behaves as an electrically conductive medium. Generally, the electrolyte solution 216 comprises electrolyte ions and thus may be referred to as an ionic solution. The electrolyte solution 216 may comprise any soluble material suitable to conduct an electric current. The electrolyte solution 216 may comprise a high concentration of ions (concentrated) or may comprise a low concentration of ions (dilute) depending on the particular application. For example, the electrolyte solution 216 may comprise a concentrated or dilute potassium hydroxide (KOH) solution. In various embodiments, the electrolyte solution 216 may comprise about a 5 to 30% KOH solution. In some embodiments, the electrolyte solution 216 may comprise about a 10 to 20% KOH solution. It will be understood that other electrolyte solutions with suitable ionic concentrations may be employed. Therefore, the embodiments are not limited in this context.

The gas sensor 200 may be coupled to one of various types of process equipment, monitors, and/or analyzers using a variety of coupling or attaching means well known to those of ordinary skill in the art. In one embodiment, the circuit board 218 comprises an energy module 220 and a battery 214. A processing module 350 of a monitor/analyzer (FIG. 3) is coupled to the gas sensor 200 via the interface 159 on the circuit board 218. The battery 214 is coupled to the energy module 220. The energy module 220 is coupled to the first, second, and third electrically conductive elements 208, 210, 212, the battery 214, and the interface 159. A cable (not shown) is received at the second end 168 through the third opening 228 to electrically couple to the interface 159. In one embodiment, the battery 214 may comprise a suitably sized zinc-air cell with adequate capacity to supply the required energy to the electrochemical cell 201 to enable oxygen reduction to occur at the sensing electrode 202 and generate an electrical current proportional thereto in the absence of any lead-based electrodes. The battery 214 and/or the energy module 220 may be employed to supply a bias voltage V_{b} to the electrochemical cell 201. In one embodiment, the bias voltage V_{b} may be applied between the sensing electrode 202 and the reference electrode 204, although the embodiments are not limited in this context.

In one embodiment, the energy module 220 scales the battery 214 voltage and applies the bias voltage V_{b} between the reference electrode 204 and the sensing electrode 202. This bias voltage enable the oxygen reduced at sensing electrode 202 and generated an current Iₒ flow through sensing electrode 202 and counter electrode 206. The sensing current Iₒ is proportional to the quantity of oxygen reduced at the sensing electrode 202. The sensing current Iₒ may be conducted outside of the electrochemical cell 201 when a load is coupled to the connectors 160A, B, which may be coupled to the load via the processing module 350 (FIG. 3). The sensing current Iₒ is coupled to the energy module 220, flows through the interface 159 (e.g., connectors 160A, B) and may be applied to the processing module 350 where it may be scaled and converted to indicate the concentration of gas reduced in the electrochemical cell 201.

In one embodiment, the energy module 220 may comprise electrical and electronic elements to maintain the potential (e.g., bias voltage V_{b}) between the reference electrode 204 and the sensing electrode 202 at a constant level. In one embodiment, the energy module 220 may comprise a potentiostat circuit to control the bias voltage V_{b} potential between the reference electrode 204 and the sensing electrode 202 and measure the sensing current Iₒ flow through the sensing electrode 202 and the counter electrode 206.

FIG. 3 is a diagram of one embodiment of a system 300 comprising the gas sensor 200. In one embodiment, the system 300 comprises the gas sensor 200 and the energy module 220 coupled to the processing module 350. In the embodiment illustrated in FIG. 3, the battery 214 is coupled to a first electronic element 304 via a network 302. The network 302 may be a resistor voltage divider circuit comprising series connected resistors R₁ and R₂. The first electronic element 304 may be a buffer amplifier A₁. The output voltage of the buffer amplifier A₁ is the bias voltage V_{b} applied to the reference electrode 204 via electrical conductive element 210. As previously discussed, the bias voltage V_{b} is applied between the reference electrode 204 and the sensing electrode 202. The sensing current Iₒ flows between the sensing electrode 202 and the counter electrode 206 when oxygen is reduced in the electrochemical cell 201 (FIG. 3) at the sensing electrode 202. The sensing current Iₒ is conducted to the energy module 220 when a load 320 is connected to the energy module 220. Although in the illustrated embodiment the load 320 is applied at the processing module 350, the load 320 may be connected in the energy module 220 without limiting the system 300 in this context. The electrical conductive element 208 couples the sensing electrode 202 to a ground terminal (return) of the energy module 220 and/or the battery 214. The electrical conductive element 212 couples the ionic sensing current Iₒ to the energy module 220.

The energy module 220 receives the sensing current Iₒ from the counter electrode 206 via the electrical conductive element 212. A second electronic element 306 amplifies and/or buffers the sensing current Iₒ, which is fed to one or more processing elements. For example, the sensing current Iₒ may be coupled to an analog-to-digital converter 308 (ADC). Once in digital form, the digitized sensing current I_{D} signal comprising up to n-bits may be processed by a processor 310. The digitized sensing current ID signal may be stored in memory 312. The processed digitized sensing current I′_{D} signal may be an identical, a scaled, or a linearized version of the digitized sensing current I_{D} signal. The digitized sensing current I′_{D} signal may be fed to a digital-to-analog converter 314 (DAC) where it may take the form of a voltage V′ₒ signal. The voltage V′ₒ signal may be readily converted to a current I′ₒ by a voltage-to-current converter 316 (V/I). The current I′ₒ is coupled to an input terminal of the processing module 350 via the first connector 160A of the two-terminal interface 159. The current I′ₒ may be equal to or proportional to the current Iₒ signal from the electrochemical cell 201 (FIG. 3). The current I′ₒ may be applied to the load 320 and coupled to additional processing circuits in the processing module 350 for scaling the current I′ₒ. The current I′ₒ signal may be processed within the processing module 350 (e.g., a gas monitor/analyzer). For example, the current I′ₒ may be amplified, converted to a digital signal suitable to drive a display 322 to indicate the gas presence/concentration. The current I′ₒ also may be compared to alarm set points to trigger an alarm 324. In the illustrated embodiment, the second connector 160B is coupled to a ground terminal of the processing module 350. The embodiments, however, are not limited in this context.

Numerous specific details have been set forth herein to provide a thorough understanding of the embodiments. It will be understood by those skilled in the art, however, that the embodiments may be practiced without these specific details. In other instances, well-known operations, components and circuits have not been described in detail so as not to obscure the embodiments. It can be appreciated that the specific structural and functional details disclosed herein may be representative and do not necessarily limit the scope of the embodiments.

It is also worthy to note that any reference to “one embodiment” or “an embodiment” means that a particular feature, structure, or characteristic described in connection with the embodiment is included in at least one embodiment. The appearances of the phrase “in one embodiment” in various places in the specification are not necessarily all referring to the same embodiment.

Some embodiments of the energy module 220 and the processing module 350 may be implemented using an architecture that may vary in accordance with any number of factors, such as desired computational rate, power levels, heat tolerances, processing cycle budget, input data rates, output data rates, memory resources, data bus speeds and other performance constraints. For example, an embodiment may be implemented using software executed by a general-purpose or special-purpose processor, such as, for example, the processor 310. In another example, an embodiment may be implemented as dedicated hardware, such as a circuit, an application specific integrated circuit (ASIC), Programmable Logic Device (PLD) or digital signal processor (DSP), and so forth. In yet another example, an embodiment may be implemented by any combination of programmed general-purpose computer components and custom hardware components. The embodiments are not limited in this context.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled”, however, may also mean that two or more elements are not in direct contact with each other, but yet still co-operate or interact with each other. The embodiments are not limited in this context.

In various implementations, the system 300 may be illustrated and described as comprising several separate functional elements, such as modules and/or blocks. Although certain modules and/or blocks may be described by way of example, it can be appreciated that a greater or lesser number of modules and/or blocks may be used and still fall within the scope of the embodiments. Further, although various embodiments may be described in terms of modules and/or blocks to facilitate description, such modules and/or blocks may be implemented by one or more hardware components (e.g., processors, DSPs, PLDs, ASICs, circuits, registers), software components (e.g., programs, subroutines, logic) and/or combination thereof.

The modules may comprise, or be implemented as, one or more systems, sub-systems, devices, components, circuits, logic, programs, or any combination thereof, as desired for a given set of design or performance constraints. For example, the modules may comprise electronic elements fabricated on a substrate. In various implementations, the electronic elements may be fabricated using silicon-based IC processes such as complementary metal oxide semiconductor (CMOS), bipolar, and bipolar CMOS (BiCMOS) processes, for example. The embodiments are not limited in this context

Unless specifically stated otherwise, it may be appreciated that terms such as “processing”, “computing”, “calculating”, “determining”, or the like, refer to the action and/or processes of a computer or computing system, or similar electronic computing device, that manipulates and/or transforms data represented as physical quantities (e.g., electronic) within the registers and/or memories of the computing system into other data similarly represented as physical quantities within the memories, registers or other such information storage, transmission or display devices of the computing system. The embodiments are not limited in this context.

While certain features of the embodiments have been illustrated as described herein, many modifications, substitutions, changes and equivalents will now occur to those skilled in the art. It is therefore to be understood that the appended claims are intended to cover all such modifications and changes as fall within the true spirit of the embodiments.

1. An oxygen gas sensor, comprising:
a body defining a cavity to contain a predetermined volume of electrolyte solution;
a plurality of electrodes disposed within the cavity, the plurality of electrodes comprises an electrically conductive material that is substantially free of hazardous material;
an energy module coupled to the plurality of electrodes, the energy module to provide a bias voltage suitable to reduce oxygen diffused in the electrolyte solution; and
an electrical interface coupled to the energy module, the electrical interface having an electrical and mechanical form-factor to enable the gas sensor to replace a lead-based anode galvanic oxygen sensor as a drop-in replacement.

2. The gas sensor of claim 1, wherein each of the plurality of electrodes comprises materials selected from the group consisting of rhodium, gold, silver, and platinum.

3. The gas sensor of claim 1, wherein each of the plurality of electrodes is substantially lead-free.

4. The gas sensor of claim 1, wherein the plurality of electrodes comprises:
a first and a second electrode adapted to couple a bias voltage therebetween from the energy module; and
a third electrode coupled to the energy module to collect an sensing current proportional to a quantity of gas reduced at the sensing electrode.

5. The sensor of claim 4, wherein the sensing current is coupled to a processing module via the electrical interface.

6. The gas sensor of claim 4, wherein the energy module comprises:
an electrical element to receive the sensing current; and
a processing element to process the sensing current.

7. The gas sensor of claim 1, further comprising a lead-free battery coupled to the energy module.

8. An electrochemical cell, comprising:
a body defining a cavity to contain a predetermined volume of electrolyte solution and a first opening to receive a gas to be diffused in the electrolyte solution; and
a plurality of electrodes disposed within the cavity, the plurality of electrodes comprises electrically conductive material that is substantially free of hazardous material, wherein at least one of the plurality of electrodes is to receive a bias voltage suitable to reduce the gas diffused in the electrolyte solution, and wherein at least one of the plurality of electrodes is configured to conduct an sensing current that is proportional to a quantity of gas that is reduced at the sensing electrode.

9. The electrochemical cell of claim 8, wherein each of the plurality of electrodes comprises materials selected from the group consisting of rhodium, gold, silver, and platinum.

10. The electrochemical cell of claim 8, wherein each of the plurality of electrodes is substantially lead-free.

11. The electrochemical cell of claim 8, wherein the plurality of electrodes comprises:
a first and a second electrode adapted to couple a bias voltage from the energy module; and
a third electrode coupled to the energy module to conduct an sensing current proportional to a quantity of oxygen gas is reduced.

12. The electrochemical cell of claim 11, wherein the first, second, and third electrodes are coupled to respective first, second, and third electrically conductive members.

13. The electrochemical cell of claim 12, wherein the first, second, and third electrically conductive elements are formed of about a 0.01 inch diameter wire of silver, nickel, platinum, gold, copper, and stainless steel that can be welded, soldered, brazed, or otherwise joined to other electrical conductor elements.

14. The electrochemical cell of claim 8, wherein the plurality of electrodes are adapted to couple to an electrical interface having an electrical and mechanical form-factor to enable the electrochemical cell to replace a lead-based anode galvanic oxygen sensor cell as a drop-in replacement.

15. The electrochemical cell of claim 8, wherein the electrolyte solution comprises a potassium hydroxide solution (KOH).

16. The electrochemical cell of claim 15, wherein the electrolyte solution comprises a 5 to 30% KOH solution.

17. The electrochemical cell of claim 16, wherein the electrolyte solution comprises a 10 to 20% KOH solution.

18. A gas measurement instrument, comprising:
a gas sensor comprising a body defining a cavity to contain a predetermined volume of electrolyte solution, a plurality of electrodes disposed within the cavity, the plurality of electrodes comprises an electrically conductive material that is substantially free of hazardous material; an energy module coupled to the plurality of electrodes, the energy module to provide a bias current suitable to reduce gas diffused in the electrolyte solution; and an electrical interface coupled to the energy module, the electrical interface having an electrical and mechanical form-factor to enable the gas sensor to replace a lead-based anode galvanic oxygen gas sensor as a drop-in replacement; and
a display to indicate the presence or concentration of the gas monitored by the gas sensor.

19. The instrument of claim 18, comprising an alarm module to compare the concentration of the monitored gas to a predetermined level and to trigger an alarm signal when the measured concentration of the monitored gas is at least at the predetermined level.

20. The instrument of claim 18, wherein each of the plurality of electrodes comprises materials selected from the group consisting of rhodium, gold, silver, and platinum.

21. The instrument of claim 20, wherein each of the plurality of electrodes is substantially lead-free.

22. The instrument of claim 18, wherein the plurality of electrodes comprises:
a first and a second electrode adapted to couple a bias voltage therebetween from the energy module; and
a third electrode coupled to the energy module and to the second electrode to conduct an sensing current from the second electrode to the third electrode, the sensing current being proportional to a quantity of gas reduced at the sensing electrode.
